(19) United States
(12) Patent Application Publication
(10) Pub. No.: US 2012/0284283 A1
(43) Pub. Date: Nov. 8, 2012

(54) Information Processing Method, Apparatus, and Computer Program

(75) Inventors: Konosuke Matsushita, Yokohama-shi (JP); Ichiro Shishido, Yokohama-shi (JP)

(73) Assignee: JVC KENWOOD Corporation, Kanagawa (JP)

(21) Appl. No.: 13/456,644

(22) Filed: Apr. 26, 2012

(30) Foreign Application Priority Data
May 6, 2011 (JP) 2011-103543

(51) Int. Cl. G06F 17/30

(52) U.S. Cl. 707/748; 707/E17.009

(57) ABSTRACT

Scores of respective content information pieces are calculated. The scores are the degrees of conformity between the content information pieces and a narrowing condition, respectively. Appropriate ones are selected from the content information pieces on the basis of the narrowing condition.

The appropriate information pieces conform to the narrowing condition. A random number sequence is acquired. The priority degrees of the respective appropriate information pieces are computed from the scores thereof and the acquired random number sequence. Indication ranks of the respective appropriate information pieces are decided on the basis of the computed priority degrees. The appropriate information pieces may be indicated according to the decided indication ranks.

### CROSS-REFERENCE TO RELATED APPLICATIONS

This application claims priority from Japanese patent application number 2011-103543, filed on May 6, 2011, the disclosure of which is hereby incorporated by reference.

### BACKGROUND OF THE INVENTION

1. Field of the Invention

This invention relates to information processing method, apparatus, and computer program concerning a decision about the order in which content-related information pieces in a set satisfying a specified condition are indicated.

2. Description of the Related Art

In recent years, as digital technologies and network technologies progress, there have been more cases where digital contents or goods are distributed and sold via a network. In addition, there have been more occasions where information is collected through the use of a search engine. Accordingly, there have been increased needs for a technology of selecting, from a plurality of contents, one or more contents a user may probably be interested in or one or more contents suiting a purpose, and providing information about the selected content or contents.

A technology of replacing a search result for a certain search condition with a new result at regular time intervals has been proposed.

Japanese patent application publication number 2010-134885 discloses a method of deciding the order in which search-result cites are indicated. The method has a step of calculating scores of cites hit in a search with a certain condition, and a step of deciding a basic order in which the hit cites are indicated according to the calculated scores. The method further has a step of shuffling hit cites in each of predetermined ranges in the basic order at a predetermined timing, and a step of deciding a final order in which the hit cites are indicated according to the result of the shuffling.

In the case where the order in which cites hit in a search with a certain condition and by a selected search engine are indicated is changed at regular time intervals, the indicated search result changes as a user repeats or reiterates the search. Thus, in this case, it can be expected that the user will employ the same search engine and conduct the search again unless the user finds a target cite in the result of the first-time conduct of the search.

In the method of Japanese application 2010-134885, when the number of hit cites in each of the predetermined ranges is relatively small, there occurs only a small change in the final order in which the hit cites are indicated. On the other hand, when the number of hit cites in each of the predetermined ranges is relatively large, the final order considerably deviates from the score-based order. Thus, in this case, a very-low-score cite may occupy a very high rank in the final order so that the indicated search result may be poor in reliability.

### SUMMARY OF THE INVENTION

It is a first object of this invention to provide an information processing method capable of deciding a variable order in which content-related information pieces in a set satisfying a specified condition are indicated wherein the order is reliable to a user and full of variety.

It is a second object of this invention to provide an information processing apparatus capable of deciding a variable order in which content-related information pieces in a set satisfying a specified condition are indicated wherein the order is reliable to a user and full of variety.

It is a third object of this invention to provide an information processing computer program capable of deciding a variable order in which content-related information pieces in a set satisfying a specified condition are indicated wherein the order is reliable to a user and full of variety.

A first aspect of this invention provides a method of processing information to select one or more from a plurality of content information pieces on the basis of a narrowing condition. The method comprises the steps of calculating scores of the respective content information pieces, the scores being degrees of conformity between the content information pieces and the narrowing condition respectively; selecting appropriate ones from the content information pieces on the basis of the narrowing condition, the appropriate information pieces conforming to the narrowing condition; acquiring a random number sequence; computing priority degrees of the respective appropriate information pieces from the scores of the appropriate information pieces and the acquired random number sequence; and deciding indication ranks of the respective appropriate information pieces on the basis of the computed priority degrees.

A second aspect of this invention is based on the first aspect thereof, and provides a method wherein the selecting step comprises selecting the appropriate information pieces from the content information pieces on the basis of the calculated scores.

A third aspect of this invention is based on the first aspect thereof, and provides a method wherein the acquiring step comprises acquiring the random number sequence which changes each time the priority degrees are computed.

A fourth aspect of this invention is based on the first aspect thereof, and provides a method further comprising the step of counting the number of times the priority degrees are computed to obtain a count number, and wherein the acquiring step comprises acquiring the random number sequence which changes for every prescribed increase in the count number.

A fifth aspect of this invention is based on the first aspect thereof, and provides a method further comprising the steps of receiving the narrowing condition; receiving a use subject identifier for identifying a terminal device sending the narrowing condition or a user using the terminal device sending the narrowing condition; counting a number of times the appropriate information pieces corresponding to the narrowing condition are required to be browsed; and storing the use subject identifier, the narrowing condition, and the counted number in a store device while relating the use subject identifier, the narrowing condition, and the counted number with each other; wherein the acquiring step comprises acquiring the counted number from the store device, and acquiring the random number sequence which changes for every prescribed increase in the counted number.

A sixth aspect of this invention is based on the first aspect thereof, and provides a method wherein the acquiring step comprises acquiring the random number sequence which changes at every prescribed time interval.

A seventh aspect of this invention is based on the first aspect thereof, and provides a method wherein the acquiring step comprises acquiring the random number sequence which changes at time intervals depending on day of the week or season.

An eighth aspect of this invention is based on the first aspect thereof, and provides a method wherein the deciding step comprises sorting the appropriate information pieces in order of decreasing score, choosing from the sorted appropriate information pieces successive ones with the scores higher than a prescribed value or a prescribed number of successive ones starting from the one with the highest score, and deciding the indication ranks of the respective chosen appropriate information pieces.

A ninth aspect of this invention is based on the first aspect thereof, and provides a method wherein the computing step comprises, for each of the appropriate information pieces, computing the priority degree thereof from the product or sum of a random number in the random number sequence and a value depending on the score.

A tenth aspect of this invention is based on the first aspect thereof, and provides a method wherein the computing step comprises, sorting the appropriate information pieces in order of decreasing score, assigning serial score ranks to the sorted appropriate information pieces respectively, and computing the priority degrees of the respective appropriate information pieces from the score ranks and the random number sequence.

An eleventh aspect of this invention is based on the tenth aspect thereof, and provides a method wherein the computing step comprises, for each of the appropriate information pieces, computing the priority degree thereof from the product or sum of a random number in the random number sequence and a value which decreases as the related score rank is lower.

A twelfth aspect of this invention is based on the first aspect thereof, and provides a method wherein the narrowing condition includes a use subject identifier for identifying a user and the appropriate information pieces are those to be recommended to the user identified by the use subject identifier, and the score of each of the appropriate information pieces increases as the degree to which the appropriate information piece is to be recommended increases.

A thirteenth aspect of this invention is based on the first aspect thereof, and provides a method wherein the appropriate information pieces relate to prescribed content information, and the score of each of the appropriate information pieces increases as the degree to which the appropriate information piece relates to the prescribed content information increases.

A fourteenth aspect of this invention is based on the first aspect thereof, and provides a method wherein the narrowing condition comprises a search condition including one or more keywords, and the score of each of the appropriate information pieces increases as the degree to which the appropriate information piece conforms to the search condition increases.

A fifteenth aspect of this invention is based on the first aspect thereof, and provides a method further comprising the steps of receiving the narrowing condition; and sending a set of the appropriate information pieces and information representing the indication ranks thereof or a set of a prescribed number of successive ones among the appropriate information pieces arranged in order of lowering indication rank and information representing the indication ranks of said successive ones.

A sixteenth aspect of this invention is based on the fifteenth aspect thereof, and provides a method further comprising the steps of sending the narrowing condition from a terminal device to a server device; receiving, at the terminal device, the appropriate information pieces and the information representing the indication ranks thereof from the server device; and indicating the received appropriate information pieces on a display section of the terminal device in accordance with the indication ranks thereof.

A seventeenth aspect of this invention provides an apparatus for processing information to select one or more from a plurality of content information pieces on the basis of a narrowing condition. The apparatus comprises a calculating section configured to calculate scores of the respective content information pieces, the scores being degrees of conformity between the content information pieces and the narrowing condition respectively; a selecting section configured to select appropriate ones from the content information pieces on the basis of the narrowing condition, the appropriate information pieces conforming to the narrowing condition; an acquiring section configured to acquire a random number sequence; a computing section to compute priority degrees of the respective appropriate information pieces from the scores of the appropriate information pieces and the acquired random number sequence; and a deciding section configured to decide indication ranks of the respective appropriate information pieces on the basis of the computed priority degrees.

An eighteenth aspect of this invention provides a computer program for enabling a computer to implement processing information to select one or more from a plurality of content information pieces on the basis of a narrowing condition. Specifically, the computer program enables the computer to implement the steps of calculating scores of the respective content information pieces, the scores being degrees of conformity between the content information pieces and the narrowing condition respectively; selecting appropriate ones from the content information pieces on the basis of the narrowing condition, the appropriate information pieces conforming to the narrowing condition; acquiring a random number sequence; computing priority degrees of the respective appropriate information pieces from the scores of the appropriate information pieces and the acquired random number sequence; and deciding indication ranks of the respective appropriate information pieces on the basis of the computed priority degrees.

This invention has the following advantages. It is possible to present, to a user, a set of content-related information pieces which is reliable to the user and full of variety. It is possible to keep users interested in services. The use of the services can be promoted.

### BRIEF DESCRIPTION OF THE DRAWINGS

FIG. 1 is a block diagram of the whole of a system in an embodiment of this invention.

FIG. 2(a) is a diagram showing an example of a picture of information pieces about recommended music contents which is indicated on a display section in FIG. 1.

FIG. 2(b) is a diagram showing an example of a picture of information pieces about book contents associated with a selected content which is indicated on the display section in FIG. 1.

FIG. 2(c) is a diagram showing an example of a picture of information pieces about contents matching a search condition which is indicated on the display section in FIG. 1.

FIG. 3 is a block diagram of an information processing server device in FIG. 1.

FIG. 4(a) is a diagram showing an example of items represented by content information pieces about books which are stored in a contents information store section in FIG. 3.

FIG. 4(b) is a diagram showing an example of items represented by content information pieces about web pages which are stored in the contents information store section in FIG. 3.

FIG. 5(a) is a diagram of an example of random number lists stored in a random number list store section in FIG. 3.

FIG. 5(b) is a diagram of an example of an item represented by random number acquisition information stored in the random number list store section in FIG. 3.

FIG. 6 is a diagram showing an example of items represented by appropriate content information pieces stored in an appropriate contents information store section in FIG. 3.

FIG. 7 is a diagram showing an example of items represented by browse count information pieces stored in the random number list store section in FIG. 3.

FIG. 8 is a flowchart showing a sequence of steps in an indication rank deciding process in the embodiment of this invention.

FIG. 9 is a diagram showing an example of situations where appropriate content information pieces are selected when a narrowing condition is a search condition including a plurality of keywords.

FIG. 10 is a flowchart showing a sequence of steps occurring in the case where a terminal device in FIG. 1 sends a narrowing condition to the information processing server device, and receives content information pieces corresponding to the narrowing condition before indicating the received content information pieces.

### DETAILED DESCRIPTION OF THE INVENTION

A system in an embodiment of this invention will be described with reference to drawings. In the following description, “contents” mean digital contents including text, audio, music, video, or web pages. Alternatively, “contents” may mean various goods or information about final instruments, real estate, or persons. Furthermore, “contents” are tangible or intangible, and are free or charged for.

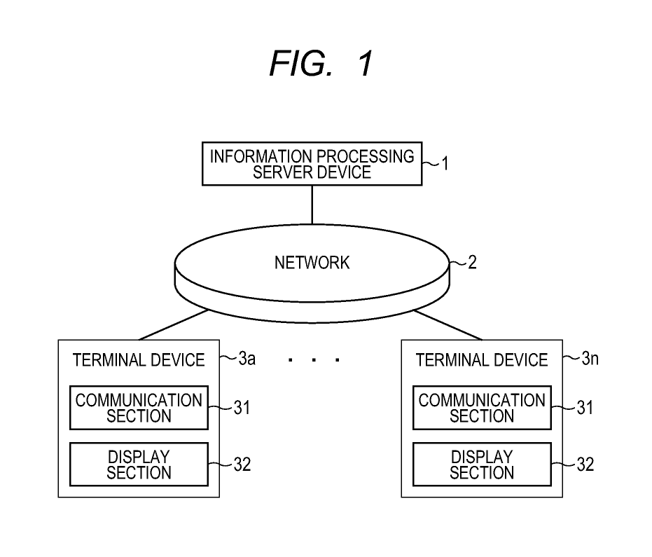

FIG. 1 is a block diagram of the whole of the system in the embodiment of this invention. As shown in FIG. 1, the system is designed so that an information processing server device 1 and one or more terminal devices 3 (3a, . . . 3n in the drawing) are connected by a network 2. Each of the terminal devices 3 can be operated and used by a user. The information processing server device 1 is shortened to the server device 1.

Preferably, only the server device 1 functions as an information processing apparatus. Alternatively, the server device 1 and at least one terminal device 3 may cooperate to function as an information processing apparatus. Each terminal device 3 may function as an information processing apparatus. An essential portion of the information processing apparatus includes an indication rank deciding section. A device having the indication rank deciding section can operate as an information processing apparatus.

Preferably, each terminal device 3 functions as an information indicating apparatus. Alternatively, the server device 1 and at least one terminal device 3 may cooperate to function as an information indicating apparatus. Only the server device 1 may function as an information indicating apparatus. A device having a means for indicating information, which results from the processing by the information processing apparatus, on an indicating section such as a display can operate as an information indicating apparatus.

A description will be given of an exemplary case where the server device 1 functions as an information processing apparatus while each terminal device 3 functions as an information indicating apparatus.

The network 2 is, for example, the Internet. Information can be transmitted between the server device 1 and the terminal devices 3 via the network 2.

Each of the terminal devices 3 is formed by a general computer including a CPU, a RAM, a ROM, an HDD (hard disk drive), a network interface, and others. Each terminal device 3 performs below-mentioned prescribed actions according to a computer program installed thereon (stored in the ROM, the HDD, or the RAM therein). Each terminal device 3 includes a communication section 31 for sending and receiving information to and from the server device 1, and a display section 32 for indicating information. Thus, each terminal device 3 can operate as an information indicating apparatus. Each terminal device 3 may be a portable or mobile device such as a personal digital assistant (PDA), a smart phone, or a cellular phone.

When sending a signal of a narrowing condition to the server device 1, each terminal device 3 receives therefrom information pieces about contents corresponding to the narrowing condition. The narrowing condition is for narrowing down a plurality of content information pieces in a contents information store section within the server device 1 into one or more content information pieces to be presented to a user. The narrowing condition varies depending on service offered by the server device 1.

In the case where the server device 1 is a cite for selling music contents or other contents and offers service for recommending a user a content or contents supposed to be accorded with user's taste in view of contents used by the user in the past, the narrowing condition is formed by a user ID (identifier) for identifying the user who uses the service or a terminal device ID (identifier) for identifying a terminal device 3 currently used by the user. The user ID or the terminal device ID is referred to as a use subject ID. In this case, when the terminal device 3 sends a signal of the use subject ID, that is, the narrowing condition, to the server device 1, the terminal device 3 receives therefrom an information piece or pieces about a content or contents recommended to the user corresponding to the sent use subject ID. The terminal device 3 indicates the received information piece or pieces on the display section 32.

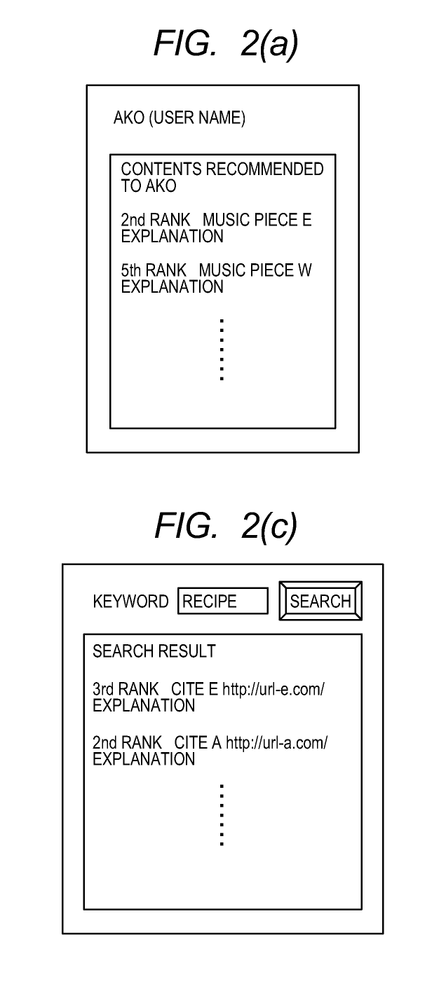

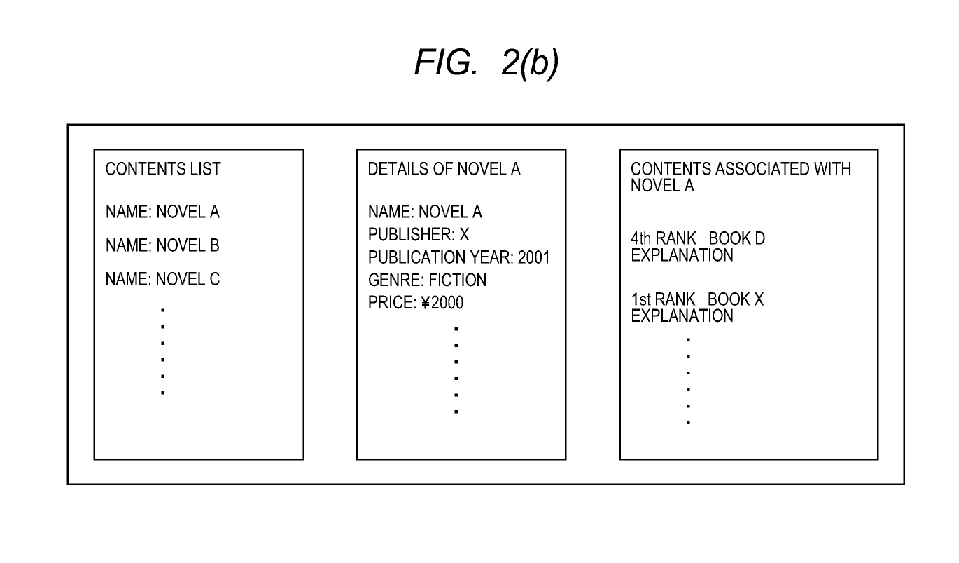

FIG. 2(a) shows an example of a picture of the information pieces about the recommended music contents which is indicated on the display section 32. In FIG. 2(a), an upper portion of the picture shows the name of the user who currently uses the terminal device 3, while mid and lower portions thereof show the information about the music contents recommended to the user. The recommended music contents may be replaced by recommended other-type contents.

In the case where the server device 1 is a cite for selling book contents or other contents and offers service for, when a user selects a content, presenting to the user an information piece or pieces about a content or contents associated with the selected content, the narrowing condition is formed by a content ID (identifier) for identifying the selected content. In this case, when a terminal device 3 sends a signal of the content ID, that is, the narrowing condition, to the server device 1, the terminal device 3 receives therefrom an information piece or pieces about a content or contents associated with the selected content corresponding to the sent content ID. The terminal device 3 indicates the received information piece or pieces on the display section 32.

FIG. 2(b) shows an example of a picture of the information pieces about the book contents associated with the selected content which is indicated on the display section 32. In FIG. 2(b), a left portion of the picture shows a list of book contents, while an intermediate portion thereof shows the details of the selected book content and a right portion thereof shows the information pieces about the book contents associated with the selected book content. The book contents may be replaced by other contents.

In the case where the server device 1 is a cite for search and offers service for presenting content information pieces matching a search condition, the narrowing condition is formed by the search condition. In this case, when a terminal device 3 sends a signal of the search condition, that is, the narrowing condition, to the server device 1, the terminal device 3 receives therefrom an information piece or pieces about a content or contents matching the search condition. The terminal device 3 indicates the received information piece or pieces on the display section 32.

FIG. 2(c) shows an example of a picture of the information pieces about the contents matching the search condition which is indicated on the display section 32. In FIG. 2(c), an upper portion of the picture has a text box into which a search condition should be inputted, and a “search” button used as a trigger about sending a signal of the inputted search condition, while mid and lower portions thereof show the information pieces about the contents matching the search condition. The contents may be of at least one of various types.

Generally, in each of the above-mentioned services, the information pieces received by the terminal device 3 concern contents respectively and are assigned to the contents respectively. The received information pieces are sorted in an order accorded with an indication order decided by the server device 1. Only a prescribed number of successive information pieces selected from the received information pieces and starting from the highest-rank information piece may be indicated. The received information pieces may be separated into groups each having successive information pieces, and the indication may be implemented on a group-by-group basis according to the indication order.

For each of the contents, the degree of conformity between the content and the narrowing condition may be given. The degree of conformity between the content and the narrowing condition is equivalent to the degree of conformity between the information piece about the content and the narrowing condition. The contents (or the information pieces) may be arranged in order of conformity degree from the highest, and assigned corresponding conformity ranks respectively. Each of the information pieces may additionally represent the corresponding conformity rank. In this case, when the information pieces are indicated, the conformity ranks assigned to the contents are indicated also. Thus, by checking the conformity ranks of the indicated information pieces, the user can judge whether or not the indicated information pieces are in a random order.

Next, a description will be given of the server device 1. The server device 1 receives a signal of a narrowing condition from a terminal device 3, and sends thereto information pieces about contents corresponding to the received narrowing condition. The server device 1 may be formed by a general computer including a CPU, a RAM, a ROM, an HDD (hard disk drive), a network interface, and others. The general computer executes a program for performing below-mentioned processes, and thereby serves as the server device 1. The program is stored in, for example, the ROM, the HDD, or the RAM.

The server device 1 may be formed by a plurality of computers. For example, to disperse load, computers are assigned to sections of the server device 1 respectively and thereby dispersedly processing is implemented. According to another example, processes by the information selecting device 10 are carried out by computers respectively so that dispersedly processing can be performed.

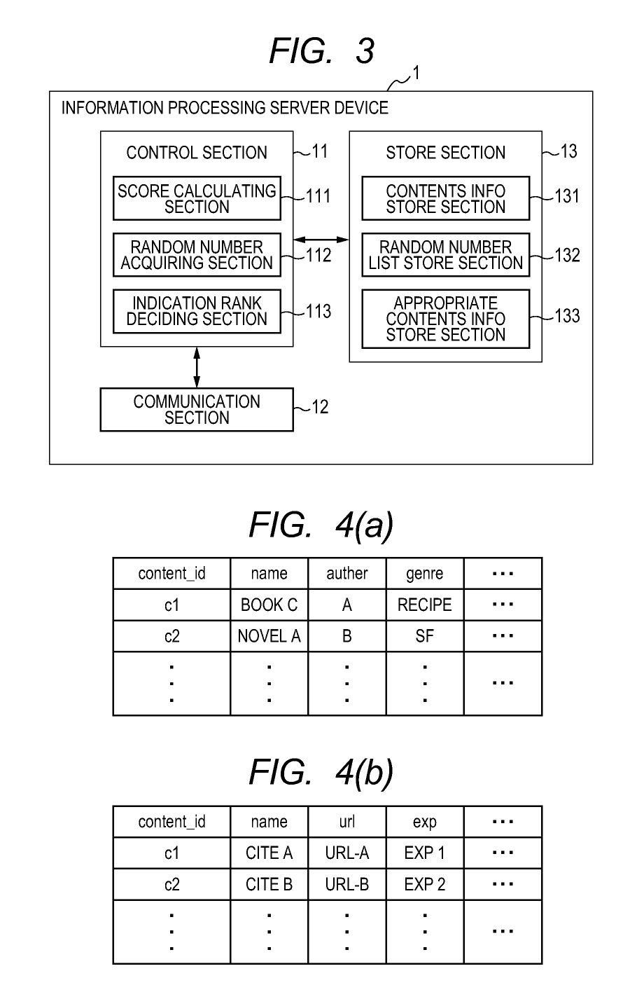

As shown in FIG. 3, the server device 1 includes a control section 11, a communication section 12, and a store section 13. The communication section 12 is designed to implement communications with the terminal devices 3 via the network 2.

The store section 13 includes a storage such as a memory or an HDD. The store section 13 stores data and information of various types. The store section 13 has a contents information store section 131, a random number list store section 132, and an appropriate contents information store section 133.

The contents information store section 131 stores a plurality of content-related information pieces (referred as content information pieces) assigned to contents respectively. Each of the content information pieces relates the ID (content ID) of the corresponding content with an information piece representative of the attributes of the corresponding content. Thus, each content information piece represents the ID of the related content and has the related-content attribute information piece. Preferably, the content information pieces are in a store format suited to the contents type.

In the case where the contents are books, the attributes of each content are the name, author, and genre of the content as shown in FIG. 4(a). In this case, the content information pieces are stored in the contents information store section 131 while the attributes (the name, author, and genre) of each content are related with the ID of the content (content_id) as shown in FIG. 4(a).

In the case where the contents are web pages, the attributes of each content are the name, URL address, and explanation of the content as shown in FIG. 4(b). In this case, the content information pieces are stored in the contents information store section 131 while the attributes (the name, URL address, and explanation) of each content are related with the ID of the content (content_id) as shown in FIG. 4(b).

Each content attribute information piece may represent items concerning the related content which differ from the above ones.

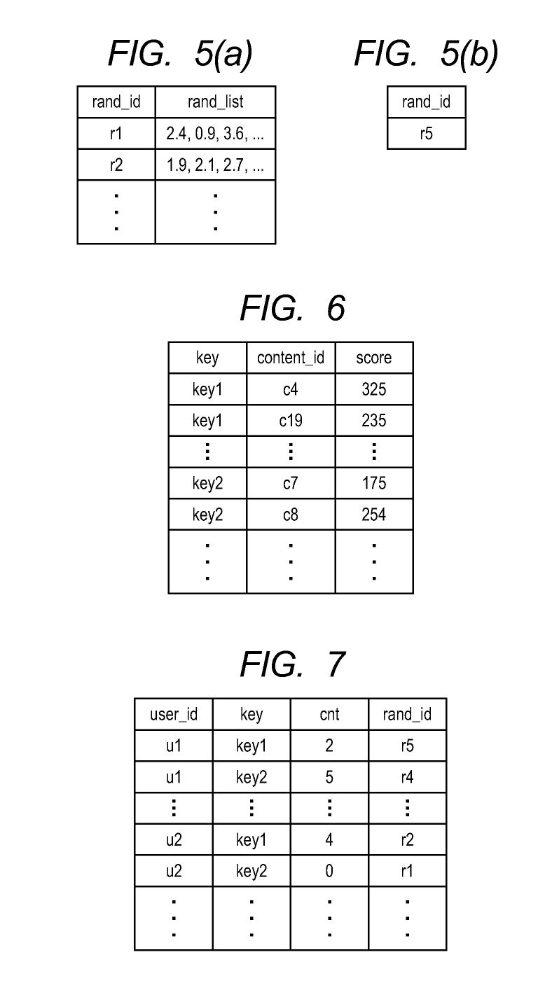

The random number list store section 132 stores a plurality of random number lists, and random number acquisition information. Each of the random number lists relates the ID of the list (rand_id) with a sequence of random numbers (rand_list) as shown in FIG. 5(a). The random number lists are stored in the random number list store section 132 while being in a table format as shown in FIG. 5(a). The number of elements of each random number sequence is equal to or greater than the number of content information pieces corresponding to a narrowing condition.

Content information pieces corresponding to a narrowing condition are selected from the content information pieces in the contents information store section 131. The selected content information pieces are stored in the appropriate contents information store section 133 while being labeled as appropriate content information pieces about appropriate contents. The number of elements of each random number sequence is equal to or greater than the number of the appropriate content information pieces (the content information pieces corresponding to the narrowing condition). A way of determining the number of elements of each random number sequence depends on whether or not a maximum store number of appropriate content information pieces is set for storing content information pieces corresponding to the narrowing condition into the appropriate contents information store section 133. In the case where the maximum store number is set, the number of elements of each random number sequence is equal to or greater than the maximum store number. On the other hand, in the case where the maximum store number is not set, the number of elements of each random number sequence is equal to or greater than the number of content information pieces in the contents information store section 131 since the greatest number of content information pieces corresponding to the narrowing condition is equal to the number of content information pieces in the contents information store section 131.

Preferably, pseudo random numbers generated by a computer are used to make the random number sequences. The computer may be one forming the server device 1. Alternatively, random numbers generated by using a dice may be employed.

The random number acquisition information is designed to identify the last random number list acquired by a random number acquiring section in the control section 11. The random number acquisition information represents the ID of the last acquired random number list (rand_id). The random number acquisition information is stored in the random number list store section 132 while being in a table format as shown in FIG. 5(b).

The appropriate contents information store section 133 stores a plurality of appropriate content information pieces assigned to appropriate contents respectively. Appropriate contents may be referred to as to-be-recommended contents also. Each of the appropriate content information pieces relates a narrowing condition (key), the ID of the corresponding content (content_id), and a score of the corresponding content which is equal to the digitized degree of conformity between the corresponding content and the narrowing condition with each other. The digitized degree of conformity between the corresponding content and the narrowing condition is equivalent to the digitized degree of conformity between the appropriate information piece about the content and the narrowing condition. Thus, each appropriate content information piece represents a narrowing condition, the ID of the corresponding content, and the score of the corresponding content. The appropriate content information pieces are stored in the appropriate contents information store section 133 while being in a table format as shown in FIG. 6. An item stored in the appropriate contents information store section 133 as a narrowing condition (key) varies from service to service. In the case of service for recommending contents to a user, the use subject ID (for example, the ID of the user) is stored in the appropriate contents information store section 133 as a narrowing condition (key). In the case of service for presenting contents associated with a certain content, the ID of the certain content is stored in the appropriate contents information store section 133 as a narrowing condition (key). In the case of service for presenting contents matching a search condition, the search condition or a keyword in the search condition is stored in the appropriate contents information store section 133 as a narrowing condition (key).

The control section 11 in the server device 1 implements overall control and arithmetic processing of various types for the sections constituting the server device 1. As shown in FIG. 3, the control section 11 includes a score calculating section 111, a random number acquiring section 112, and an indication rank deciding section 113.

The score calculating section 111 implements a process of selecting appropriate contents, that is, a process of selecting appropriate ones from the content information pieces in the contents information store section 131. Preferably, the appropriate contents selecting process is performed each time the server device 1 receives a signal of a narrowing condition from a terminal device 3. Alternatively, the server device 1 may sample a narrowing condition at every prescribed timing and perform the appropriate contents selecting process in response to each resultant sample of the narrowing condition. Every prescribed timing may be given by a service provider side.

The server device 1 may sample a narrowing condition at intervals of 24 hours and perform the appropriate contents selecting process in response to each resultant sample of the narrowing condition. The prescribed timing for sampling a narrowing condition may be a timing at which the number of times of reception of a use history reaches a predetermined value. The server device 1 may sample a narrowing condition at variable time intervals and perform the appropriate contents selecting process in response to each resultant sample of the narrowing condition. In this case, the time intervals may be 3 hours from Monday to Friday, 6 hours on Saturday and 12 hours on Sunday. Alternatively, the time intervals may depend on season. For example, the time intervals are set to a first predetermined value in summer and a second predetermined value in winter, and the first predetermined value is smaller than the second predetermined value.

Preferably, a way of sampling a narrowing condition varies from service to service. It is preferable to provide information pieces representing the attributes of respective users who can use service. The IDs of the users (use subject IDs) and the user attribute information pieces are stored in a prescribed area in the store section 13 of the server device 1 while being related with each other. In the case of service for recommending contents to a user, when the appropriate contents selecting process is required to be performed, the ID of the user (use subject ID) is read out from the prescribed area in the store section 13 as a narrowing condition.

In the case of service for presenting contents associated with a certain content, when the appropriate contents selecting process is required to be performed, the ID of the certain content is read out from the contents information store section 131 as a narrowing condition.

When contents are web pages, it is preferable to subject text information in each of the web pages to a known morphological analysis to extract a keyword or keywords. Each content attribute information piece is designed to additionally represent an extracted keyword or keywords. Content attribute information pieces for the respective web pages are stored in the contents information store section 131. In the case of service for presenting contents matching a search condition, when the appropriate contents selecting process is required to be performed, a keyword or keywords corresponding to the search condition are read out from the contents information store section 131 as a narrowing condition.

The score calculating section 111 implements a process of selecting appropriate contents, that is, a process of selecting appropriate ones from the content information pieces in the contents information store section 131. The appropriate contents selecting process has a step of accessing the contents information store section 131 to detect each content or the ID of each content, a step of calculating the score of each content (the degree of conformity between a narrowing condition and the content information piece about each content), a step of selecting appropriate ones from the contents on the basis of the calculated scores, and a step of storing, into the appropriate contents information store section 133, appropriate content information pieces relating the narrowing condition, the IDs of the selected appropriate contents, and the calculated scores of the selected appropriate contents with each other. A way of calculating the score of each content may vary from service to service.

Only the scores of some of all contents may be calculated. For example, only the scores of contents, among all contents, which have a specified relation with a narrowing condition may be calculated.

All appropriate content information pieces may be stored in the appropriate contents information store section 133. Alternatively, only ones among all appropriate content information pieces which represent scores greater than a value predetermined by the service provider side may be stored in the appropriate contents information store section 133. All appropriate content information pieces may be arranged according to score. In this case, only a predetermined number of successive appropriate content information pieces starting from one representing the highest score are stored in the appropriate contents information store section 133. The predetermined number is given by the service provider side.

In the case where old appropriate content information pieces are in the appropriate contents information store section 133, the old appropriate information pieces are erased therefrom before new appropriate content information pieces are stored thereinto.

Appropriate contents selecting processes for three different services will be described below. An appropriate contents selecting process regarding service for recommending contents to a user is as follows. There are provided use histories indicating historical conditions of use of contents by users. Preferably, the use histories are stored in the store section 13. The score calculating section 111 selects users similar to a user corresponding to a narrowing condition (a user of interest or a target user) by referring to the use histories. Preferably, the degree of similarity between the user of interest and each of other users is calculated by employing a Jaccard coefficient, and users similar to the user of interest are selected according to the calculated similarity degrees. Specifically, a set of contents which were used by the user of interest is denoted by C(ub). A set of contents which were used by another user is denoted by C(us). The number of common contents in both the contents sets C(ub) and C(us) is expressed by |C(ub)∩C(us)|. The number of contents in at least one of the contents sets C(ub) and C(us) is expressed by |C(ub)∪C(us)|. The degree sim(ub, us) of similarity between the user of interest and another user is calculated according to the following equation (1).

$$sim ( ub , us ) = \frac{\vert C ( ub ) ⋂ C ( us ) \vert}{\vert C ( ub ) ⋃ C ( us ) \vert} \qquad ( 1 )$$

The contents except the user of interest are arranged in order of decreasing similarity degree. Then, a prescribed number of successive users starting from the user corresponding to the highest similarity degree are selected as users similar to the user of interest. Alternatively, users corresponding to similarity degrees higher than a prescribed value are selected as users similar to the user of interest. In the case where the degrees of taste (preference) for items are calculated for each user, cosine distances or Peason product-moment correlation coefficients can be employed for the calculation of similarity degrees.

Next, the score calculating section 111 detects contents which were used by the selected users similar to the user of interest. The score calculating section 111 labels the detected contents as recommendation candidate contents. Contents which were used by the user of interest may be excluded from the detected contents or the recommendation candidate contents.

Subsequently, the score calculating section 111 calculates the degree of conformity between the user of interest and each of the recommendation candidate contents. The conformity degree calculation may employ the degrees of similarity between the user of interest and the users similar to the user of interest. Specifically, a recommendation candidate content is denoted by “cr”, and the user of interest is denoted by “ub”. Users who are similar to the user “ub” and who used the recommendation candidate content “cr” are denoted by Us(ub, cr). A user who is similar to the user “ub” and who used the recommendation candidate content “cr” is denoted by us' (∈ Us(ub, cr)). The degree of similarity between the user “ub” and the user us' (∈ Us(ub, cr)) is expressed by sim(ub, us′). The degree v(ub, cr) of conformity between the user “ub” (the user of interest) and the recommendation candidate content “cr” is calculated according to the following equation (2).

$$v ( ub , cr ) = {\sum }_{{us}^{′} ∈ Us ( ub , cr )} sim ( ub , {us}^{′} ) \qquad ( 2 )$$

Thereafter, the score calculating section 111 selects contents to be recommended (appropriate contents) from the recommendation candidate contents. All the recommendation candidate contents may be labeled as to-be-recommended contents (appropriate contents). Preferably, the recommendation candidate contents are arranged in order of decreasing conformity degree. Then, a prescribed number of successive recommendation candidate contents starting from the recommendation candidate content corresponding to the highest conformity degree are selected as to-be-recommended contents. Alternatively, recommendation candidate contents corresponding to conformity degrees higher than a prescribed value may be selected as to-be-recommended contents.

Subsequently, for each to-be-recommended content, the score calculating section 111 stores the ID of the user of interest (the narrowing condition), the ID of the to-be-recommended content, and the corresponding conformity degree (score) into the appropriate contents information store section 133 while relating them with each other.

A way different from the above-mentioned way may be employed for selecting recommendation candidate contents for the user of interest, calculating the degrees of conformity with respect to the selected recommendation candidate contents, and selecting to-be-recommended contents from the recommendation candidate contents in accordance with the calculated conformity degrees.

An appropriate contents selecting process regarding service for presenting contents associated with a certain content is as follows. There are provided use histories indicating historical conditions of use of contents by users. Preferably, the use histories are stored in the store section 13. The score calculating section 111 selects association candidate contents for a content corresponding to a narrowing condition (a content of interest) by referring to the use histories. Preferably, the selection of association candidate contents is in a way having a step of forming a set of users who used the content of interest, and a step of labeling contents which were used by at least one of the users in the formed set as association candidate contents. The content of interest may be excluded from the association candidate contents.

Next, the score calculating section 111 calculates the degree of conformity between the content of interest and each of the association candidate contents. The conformity degree calculation may employ a Jaccard coefficient. Specifically, the content of interest is denoted by “cb”, and an association candidate content is denoted by “cs”. A set of users who used the content of interest is denoted by U(cb). A set of users who used the association candidate content is denoted by U(cs). The number of common users in both the user sets U(cb) and U(cs) is expressed by |U(cb)∩(cs)|. The number of users in at least one of the user sets U(cb) and U(cs) is expressed by |U(cb)∪(cs)|. The degree v(cb, cs) of conformity between the content of interest and the association candidate content is calculated according to the following equation (3).

$$v ( cb , cs ) = \frac{\vert U ( cb ) ⋂ U ( cs ) \vert}{\vert U ( cb ) ⋃ U ( cs ) \vert} \qquad ( 3 )$$

In the case where the degrees of taste (preference) for items are calculated for each user, cosine distances or Peason product-moment correlation coefficients can be employed for the calculation of conformity degrees.

Thereafter, the score calculating section 111 selects associated contents (contents regarded as being associated with the content of interest) from the association candidate contents. All the association candidate contents may be labeled as associated contents (appropriate contents). Preferably, the association candidate contents are arranged in order of decreasing conformity degree. Then, a prescribed number of successive association candidate contents starting from the association candidate content corresponding to the highest conformity degree are selected as associated contents. Alternatively, association candidate contents corresponding to conformity degrees higher than a prescribed value may be selected as associated contents.

Subsequently, for each associated content, the score calculating section 111l stores the ID of the content of interest (the narrowing condition), the ID of the associated content, and the corresponding conformity degree (score) into the appropriate contents information store section 133 while relating them with each other.

A way different from the above-mentioned way may be employed for selecting association candidate contents for the content of interest, calculating the degrees of conformity with respect to the selected association candidate contents, and selecting associated contents from the association candidate contents in accordance with the calculated conformity degrees.

An appropriate contents selecting process regarding service for presenting contents matching a search condition is as follows. The score calculating section 111 selects contents in accordance with the search condition (the narrowing condition) as search object contents by referring to the content information pieces in the contents information store section 131. When all keywords in the search condition are combined under an AND condition, contents corresponding to content attribute information pieces each representing all the keywords are selected as search object contents. When all keywords in the search condition are combined under an OR condition, contents corresponding to content attribute information pieces each representing at least one of all the keywords are selected as search object contents.

Next, the score calculating section 111 calculates the degree of conformity between the narrowing condition and each of the search object contents. The conformity degree calculation may be in a conventional tf-idf method. Specifically, the summation of the frequencies of appearance of all words in text information in a web page “p” forming a search object content is denoted by “n(p)”. The frequency of appearance of an arbitrary keyword “w” in a set “W” of keywords in the narrowing condition is denoted by “n(p, w)”. The number of members of a set D of all content information pieces in the contents information store section 131 is denoted by I D I . The number of content information pieces, in the set D, each containing the keyword “w” is denoted by I D(w) I . The degree v(W, p) of conformity between the narrowing condition and the search object content is calculated according to the following equation (4).

$$v ( W , p ) = {\sum }_{w ∈ W} \frac{n ( p , w )}{n ( p )} \times log \frac{\vert D \vert}{\vert D ( w ) \vert} \qquad ( 4 )$$

Thereafter, the score calculating section 111 selects search result contents from the search object contents. All the search object contents may be labeled as search result contents (appropriate contents). Preferably, the search object contents are arranged in order of decreasing conformity degree. Then, a prescribed number of successive search object contents starting from the search object content corresponding to the highest conformity degree are selected as search result contents. Alternatively, search object contents corresponding to conformity degrees higher than a prescribed value may be selected as search result contents.

Subsequently, for each search result content, the score calculating section 111 stores the narrowing condition, the ID of the search result content, and the corresponding conformity degree (score) into the appropriate contents information store section 133 while relating them with each other.

A way different from the above-mentioned way may be employed for selecting search object contents in accordance with the search condition (the narrowing condition), calculating the degrees of conformity with respect to the selected search object contents, and selecting search result contents from the search object contents in accordance with the calculated conformity degrees.

When receiving a request for a random number list from the indication rank deciding section 113, the random number acquiring section 112 acquires a new random number list from the random number list store section 132. The new random number list differs from the previously-acquired random number list. Specifically, the random number acquiring section 112 detects the ID of the last acquired random number list (rand_id) which is represented by the random number acquisition information in the random number list store section 132. Then, the random number acquiring section 112 decides or selects a new list ID different from the detected list ID. Subsequently, the random number acquiring section 112 acquires, from the random number list store section 132, a new random number list assigned the same list ID as the new list ID. The new list ID may be one corresponding to a random number list stored at a place (an address) next to the place of the last acquired random number list. The random number acquiring section 112 updates the random number acquisition information in the random number list store section 132 to represent the new list ID.

Preferably, the random number acquiring section 112 acquires a new random number list each time the server device 1 receives a signal of a narrowing condition from a terminal device 3. In this case, the random number acquiring section 112 acquires a new random number list different from the previously-acquired random number list each time the indication rank deciding section 113 calculates priority degrees as will be mentioned later.

The random number acquiring section 112 may employ pseudo random numbers generated by the computer forming the server device 1 instead of random number lists in the random number list store section 132. In this case, the random number list store section 132 may be omitted.

A new random number list different from the last acquired random number list may be acquired for every prescribed number of times a content corresponding to a narrowing condition is browsed (indicated). In this case, instead of managing the last acquired random number list by using the random number acquisition information in the random number list store section 132, it is good to manage a random number list for each user and each narrowing condition by using information (browse count information) about the number of times browse is done.

Preferably, the browse count information has pieces each representing the ID of a user (a use subject ID), a narrowing condition (key), a browse count (cnt) equal to the number of times a content information piece corresponding to the narrowing condition is browsed by the user, and a random number list ID (rand_id) while relating them with each other. The browse count information is stored in the random number list store section 132 while being in a table format as shown in FIG. 7.

A detailed description will be given of acquiring a new random number list different from the last acquired random number list for every prescribed number of times a content information piece corresponding to a narrowing condition is browsed (indicated).

Firstly, the random number acquiring section 112 obtains a use subject ID and a narrowing condition from the indication rank deciding section 113.

Secondly, the random number acquiring section 112 accesses the random number list store section 132 and detects a browse count information piece therein which corresponds to the obtained use subject ID and the obtained narrowing condition. The random number acquiring section 112 adds “1” to a browse count represented by the detected browse count information piece, and thereby updates the detected browse count information piece.

Then, the random number acquiring section 112 determines whether or not the browse count represented by the updated browse count information piece is equal to one of multiples of a prescribed integer. When the browse count is equal to one of multiples, the random number acquiring section 112 acquires, from the random number list store section 132, a random number list assigned an ID different from the random number list ID represented by the browse count information piece corresponding to the obtained use subject ID and the obtained narrowing condition. For example, the random number acquiring section 112 acquires a random number list stored at a place (an address) next to the place of the random number list assigned the ID represented by the browse count information piece. The random number list store section 132 replaces the random number list ID in the browse count information piece in the random number list store section 132 with the ID of the acquired random number list. On the other hand, when the browse count is equal to none of multiples, the random number acquiring section 112 obtains, from the random number list store section 132, the random number list ID represented by the browse count information piece corresponding to the obtained use subject ID and the obtained narrowing condition.

Each time the browse count reaches a prescribed integer, the browse count may be reset to “0” and a new random number list different from the last acquired random number list may be acquired.

In the case of service where a narrowing condition is a use subject ID, only the narrowing condition, a browse count, and a random number list ID may be stored in the random number list store section 132 while being related with each other to form a browse count information piece. In the case where simplifying the overall processing is desired, only a narrowing condition, a browse count, and a random number list ID may be stored in the random number list store section 132 while being related with each other to form a browse count information piece regardless of whether or not the narrowing condition is a use subject ID.

The prescribed integer determines a timing at which an employed random number list is changed or updated. Preferably, the prescribed integer is set by the service provider side. The prescribed integer may freely be set by a user who uses service.

In the case where the prescribed integer is “1”, it is good to acquire a new random number list different from the last acquired random number list for every time without employing the browse count information. On the other hand, in the case where the prescribed integer is “2” or greater, it is good to employ the browse count information.

The employment of the browse count information allows a random number list different from the last acquired random number list to be acquired for every increase in browse count by a prescribed integer. In other words, the currently-acquired random number list changes for every increase in browse count by the prescribed integer. The random number acquiring section 112 notifies the currently-acquired random number list to the indication rank deciding section 113. The indication rank deciding section 113 decides indication ranks in response to the currently-acquired random number list. The decided indication ranks vary for every increase in browse count by the prescribed integer since the currently-acquired random number list changes as above mentioned.

A random number list different from the last acquired random list may be acquired at every prescribed timing by employing, for example, a timer function. Specifically, at every prescribed timing, the control section 11 in the server device 1 may update the random number list ID represented by the random number acquisition information in the random number list store section 132 into a different random number list ID. In this case, the random number acquiring section 112 is designed not to implement the updating of the random number acquisition information.

The prescribed timing corresponds to prescribed intervals of time, for example, intervals of 10 minutes. In this case, the acquired random number list changes at the prescribed time intervals. The prescribed time intervals may be replaced by variable time intervals. In this case, the time intervals in question may be 60 minutes in the morning, 30 minutes in the daytime, 20 minutes in the evening, 40 minutes in the night, and 90 minutes in the middle of the night. The time intervals may be 60 minutes from Monday to Friday, and 30 minutes on Saturday and 20 minutes on Sunday. Alternatively, the time intervals may depend on season. For example, the time intervals are set to a first predetermined value in summer and a second predetermined value in winter, and the first predetermined value is smaller than the second predetermined value. The time intervals may be varied at random.

For the generation of pseudo random numbers, the computer (for example, the computer forming the server device 1) may employ a method of designating a seed and generating a pseudo random number sequence in response to the designated seed. Pseudo random number sequences generated in this method by the computer can replace random number lists in the random number list store section 132 in the case where the acquired random number set (list or sequence) is designed to change for every increase in browse count by a prescribed integer or in the case where the acquired random number set (list or sequence) is designed to change at every prescribed timing. It is good to manage the seed employed for generating the last pseudo random number sequence.

When receiving a signal of a narrowing condition from a terminal device 3, the indication rank deciding section 113 performs a process of deciding indication ranks of information pieces about respective appropriate contents. The indication ranks deciding process is as follows.

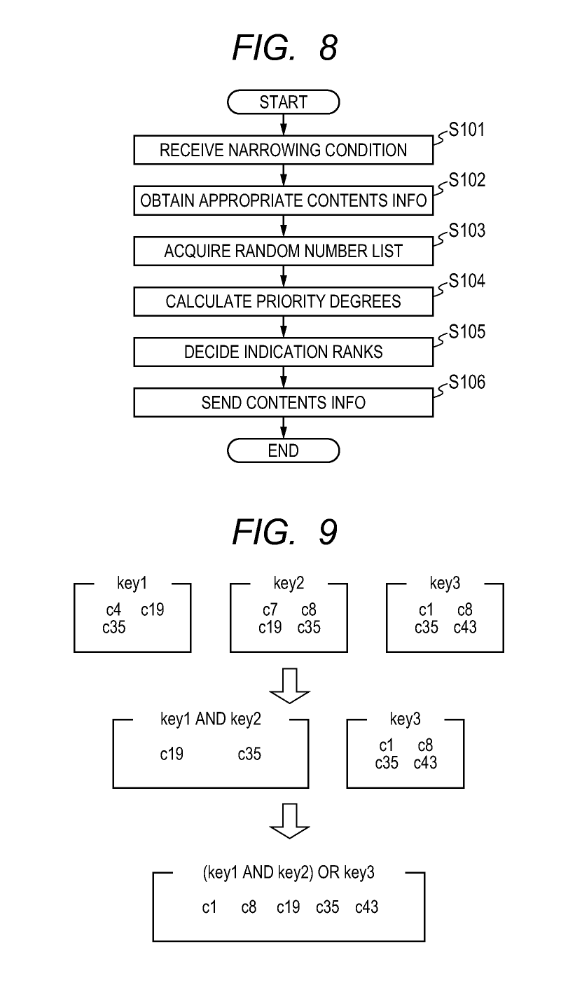

With reference to FIG. 8, the indication rank deciding section 113 receives a signal of a narrowing condition from a terminal device 3 via the network 2 in a step S101.

In a step S102 following the step S101, the indication rank deciding section 113 obtains or takes appropriate content information pieces corresponding to the received narrowing condition from the appropriate contents information store section 133.

In the case where each narrowing condition is one condition such as a use subject ID, the indication rank deciding section 113 compares the received narrowing condition with narrowing conditions (key) represented by respective appropriate content information pieces in the appropriate contents information store section 133. Then, the indication rank deciding section 113 takes appropriate content information pieces representing narrowing conditions equal to the received narrowing condition.

In the case where each narrowing condition is a search condition having an AND or OR combination of plural keywords, the indication rank deciding section 113 performs actions depending on whether or not the received narrowing condition is equal to at least one of narrowing conditions (key) represented by respective appropriate content information pieces in the appropriate contents information store section 133. When the received narrowing condition is equal to at least one of the narrowing conditions (key) represented by the respective appropriate content information pieces, the indication rank deciding section 113 takes one or more appropriate content information pieces representing narrowing conditions equal to the received narrowing condition. When the received narrowing condition is equal to none of the narrowing conditions (key) represented by the respective appropriate content information pieces, the indication rank deciding section 113 determines whether or not at least one keyword in the received narrowing condition is equal to at least one of the narrowing conditions (key) represented by the respective appropriate content information pieces. If at least one keyword in the received narrowing condition is equal to at least one of the narrowing conditions (key) represented by the respective appropriate content information pieces, the indication rank deciding section 113 takes one or more appropriate content information pieces on a keyword-by-keyword basis and implements a narrowing action in accordance with the received narrowing condition (search condition).

FIG. 9 shows a situation where the received narrowing condition (search condition) is “(keyl AND key2) OR key3”; content IDs in appropriate content information pieces assigned the keyword “key1” are c4, c19, and c35; content IDs in appropriate content information pieces assigned the keyword “key2” are c7, c8, c19, and c35; and content IDs in appropriate content information pieces assigned the keyword “key3” are c1, c8, c35, and c43. In this situation, for “key1 AND key2” in the received narrowing condition, the indication rank deciding section 113 takes the common content IDs c19 and c35 in both a group of the appropriate content information pieces assigned the keyword “key1” and a group of the appropriate content information pieces assigned the keyword “key2”. For “key3” in the received narrowing condition, the indication rank deciding section 113 takes all the content IDs c1, c8, c35, and c43 in the appropriate content information pieces assigned the keyword “key3”. Thereafter, for “OR” in the received narrowing condition, the indication rank deciding section 113 takes the content IDs c1, c8, c19, c35, and c43. Accordingly, the indication rank deciding section 113 obtains, from the appropriate contents information store section 133, appropriate content information pieces assigned the content IDs c1, c8, c19, c35, and c43.

The appropriate content information pieces corresponding to the narrowing condition may be arranged in order of decreasing conformity degree. In this case, a prescribed number of successive appropriate content information pieces starting from the appropriate content information piece corresponding to the highest conformity degree may be selected as obtained appropriate content information pieces. The prescribed number is given by the contents provider side. Each of the terminal devices 3 may send a signal of an upper limit of the number of obtained appropriate content information pieces to the server device 1. In this case, it is desirable that the number of appropriate content information pieces obtained by the indication rank deciding section 113 is equal to or greater than the upper limit number. Accordingly, when the indication rank deciding section 113 receives a signal of an upper limit number from a terminal device 3 in addition to a narrowing condition, the prescribed number is set to, for example, twice the received upper limit number. Thus, the indication rank deciding section 113 obtains, from the appropriate contents information store section 133, the prescribed number of appropriate content information pieces which is equal to twice the received upper limit number. As previously mentioned, the obtained appropriate content information pieces are in order of decreasing conformity degree.

With reference back to FIG. 8, in a step S103 following the step S102, the random number acquiring section 112 acquires a random number list from the random number list store section 132.

In a step S104 subsequent to the step S103, the indication rank deciding section 113 calculates a priority degree for each of content IDs in the appropriate content information pieces acquired in the step S102 from the corresponding score and the random number list acquired by the random number list store section 132. In the case where at least two of the appropriate content information pieces acquired in the step S102 represent a same content ID, the indication rank deciding section 113 recalculates a final score for the same content ID by, for example, summing the current scores represented by the related appropriate content information pieces. In the situation of FIG. 9, the score for the content ID “c19” in the appropriate content information piece assigned the keyword “key1” and the score for the content ID “c19” in the appropriate content information piece assigned the keyword “key2” are added, and the result of this addition is labeled as a final score for the content ID “c19”.

The priority degree calculation is in one of first, second, third, and fourth methods explained hereafter. A set of content IDs represented by appropriate content information pieces corresponding to a narrowing condition “k” is denoted by C(k). The i-th content ID in the set C(k) is denoted by c(i) (∈ C(k)). The score (conformity degree) corresponding to the content ID “c(i)” is denoted by v(k, c(i)). The i-th random number in a random number list R acquired in the step S103 is denoted by r(i). The content IDs represented by the appropriate content information pieces are sorted in order of decreasing score, and serial or successive ranks are assigned to the sorted content IDs respectively. The rank assigned to the i-th one among the sorted content IDs is denoted by rank(k, c(i)).

The first method for the priority degree calculation has a step of performing exponentiation involving a base being the score of the content ID “c(i)” and an exponent being a constant yl greater than 0. The first method has a step of calculating the priority degree pr(k, c(i)) for the content ID “c(i)” according to the following equation (5).

pr(k, c(i))=v(k, c(i))^{γ}^{₁}×r(i) (5)

The random number r(i) needs to be a real value greater than 0. After all priority degrees have been calculated, different indication ranks are assigned to the respective content IDs in the set C(k) on the basis of the calculated priority degrees. The first method causes a high probability that a content ID with a higher score will be assigned a higher indication rank. The random number less affects the calculated priority degree as the constant yl increases. The random number greatly affects the calculated priority degree when the constant yl is smaller than 1, and slightly affects the calculated priority degree when the constant yl is greater than 1.

The second method for the priority degree calculation has a step of performing exponentiation involving a base being the score of the content ID “c(i)” and an exponent being a constant γ2 greater than 0. The second method has a step of calculating the priority degree pr(k, c(i)) for the content ID “c(i)” according to the following equation (6).

pr(k, c(i))=α2×v(k, c(i))^{γ}^{₂}+r(i) (6)

where α2 denotes a constant greater than 0. The random number r(i) is free from the restriction imposed in the first method. After all priority degrees have been calculated, different indication ranks are assigned to the respective content IDs in the set C(k) on the basis of the calculated priority degrees. The second method causes a high probability that a content ID with a higher score will be assigned a higher indication rank. The random number less affects the calculated priority degree as the constant α2 increases. The random number greatly affects the calculated priority degree when the constant α2 is smaller than 1, and slightly affects the calculated priority degree when the constant α2 is greater than 1. The random number less affects the calculated priority degree as the constant γ2 increases. The random number greatly affects the calculated priority degree when the constant γ2 is smaller than 1, and slightly affects the calculated priority degree when the constant γ2 is greater than 1.

The third method for the priority degree calculation has a step of performing exponentiation involving a base being the rank of the content ID “c(i)” and an exponent being a constant γ3 greater than 0. The third method has a step of calculating the priority degree pr(k, c(i)) for the content ID “c(i)” according to the following equation (7).

$$pr ( k , c ( i ) ) = r ( i ) \times \frac{1}{{rank ( k , c ( i ) )}^{γ 3}} \qquad ( 7 )$$

The random number r(i) needs to be a real value greater than 0. After all priority degrees have been calculated, different indication ranks are assigned to the respective content IDs in the set C(k) on the basis of the calculated priority degrees. The third method causes a high probability that a content ID with a higher score will be assigned a higher indication rank. The random number less affects the calculated priority degree as the constant γ3 increases. The random number greatly affects the calculated priority degree when the constant γ3 is smaller than 1, and slightly affects the calculated priority degree when the constant γ3 is greater than 1. The last term in the equation (7) takes a smaller value as the rank is lower.

The fourth method for the priority degree calculation has a step of performing exponentiation involving a base being the rank of the content ID “c(i)” and an exponent being a constant γ4 greater than 0. The fourth method has a step of calculating the priority degree pr(k, c(i)) for the content ID “c(i)” according to the following equation (8).

$$pr ( k , c ( i ) ) = r ( i ) + \frac{α 4}{{rank ( k , c ( i ) )}^{γ 4}} \qquad ( 8 )$$

where α4 denotes a constant greater than 0. The random number r(i) is free from the restriction imposed in the third method. After all priority degrees have been calculated, different indication ranks are assigned to the respective content IDs in the set C(k) on the basis of the calculated priority degrees. The fourth method causes a high probability that a content ID with a higher score will be assigned a higher indication rank. The random number less affects the calculated priority degree as the constant α4 increases. The random number greatly affects the calculated priority degree when the constant α4 is smaller than 1, and slightly affects the calculated priority degree when the constant α4 is greater than 1. The random number less affects the calculated priority degree as the constant γ4 increases. The random number greatly affects the calculated priority degree when the constant γ4 is smaller than 1, and slightly affects the calculated priority degree when the constant γ4 is greater than 1. The last term in the equation (8) takes a smaller value as the rank is lower.

The first, second, third, and fourth methods for the priority degree calculation may be replaced by a method in which a priority degree for each of contents IDs in the set C(k) is calculated from the corresponding score (or a value computed by using the score) and the corresponding random number so as to cause a high probability that a content ID with a higher score will be assigned a higher indication rank. The priority degree may be equal to the score divided by the random number, where the random number is a real value greater than 0. In this case, the priority degree increases as the random number decreases, and there is a high probability that a content ID with a higher score will be assigned a higher indication rank.

In a step S105 following the step S104, the indication rank deciding section 113 acts with respect to the content IDs in the appropriate content information pieces acquired in the step S102, and arranges the content IDs in the order of decreasing priority degree calculated in the step S104. Then, the indication rank deciding section 113 assigns serial or successive indication ranks to the arranged content IDs respectively. Thus, a content ID with a higher priority degree is assigned a higher indication rank. A content ID with a lower priority degree is assigned a lower indication rank. In this way, the indication rank deciding section 113 decides indication ranks assigned to respective content IDs. Generally, as will be made clear later, assigning the serial or successive indication ranks to the arranged content IDs respectively results in the decision of the order in which content information pieces are indicated.

Next, the indication rank deciding section 113 obtains, from the contents information store section 131, content information pieces corresponding to the content IDs represented by the appropriate content information pieces acquired in the step S102. Alternatively, the indication rank deciding section 113 may obtain the content information pieces from the appropriate contents information store section 133. The indication rank deciding section 113 sorts the obtained content information pieces in the order of indication rank given in the step S105.

In a step S106 subsequent to the step S105, the communication section 12 in the server device 1 sequentially sends the sorted content information pieces to the terminal device 3 via the network 2. The sequential processing that has started from the step S101 ends at the step S106.

The content information pieces obtained in the step S106 may be sorted in the order of decreasing score. In this case, serial or successive score ranks are assigned to the sorted content information pieces respectively. Preferably, the score ranks are added to the content information pieces sent to the terminal device 3.

In the case where the indication rank deciding section 113 receives, from the terminal device 3, not only the signal of the narrowing condition but also the signal of the upper limit of the number of obtained appropriate content information pieces, the following additional actions are performed in the step S106. The indication rank deciding section 113 or the communication section 12 selects, among the sorted content information pieces directed to the terminal device 3, the upper limit number of successive ones starting from the content information piece with the highest indication rank. Then, the communication section 12 sequentially sends the selected content information pieces to the terminal device 3.

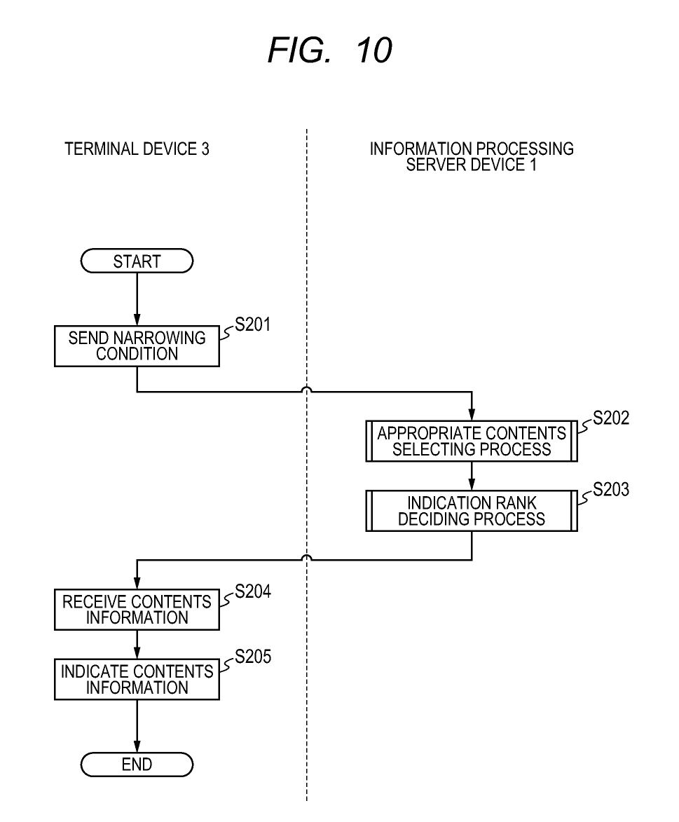

With reference to FIG. 10, a description will be given of the sequential processing for enabling a terminal device 3 to send a signal of a narrowing condition to the server device 1, and receive and indicate content information pieces corresponding to the narrowing condition.

Firstly, in a step S201, a terminal device 3 sends a signal of a narrowing condition to the server device 1 via the network 2.

In a step S202 following the step S201, the communication section 12 in the server device 1 receives the signal of the narrowing condition via the network 2. The score calculating section 111 in the server device 1 implements the previously-mentioned process of selecting appropriate contents in accordance with the narrowing condition.

In a step S203 subsequent to the step S202, the indication rank deciding section 113 in the server device 1 performs the previously-mentioned process of deciding indication ranks of the appropriate contents (the content information pieces corresponding to the narrowing condition). The communication section 12 in the server device 1 sends content information pieces concerning the appropriate contents and sorted in order of indication rank to the terminal device 3 via the network 2. In other words, the communication section 12 sends the terminal device 3 the content information pieces corresponding to the narrowing condition and sorted in order of indication rank.

In a step S204 following the step S203, the terminal device 3 receives, from the server device 1 via the network 2, the content information pieces corresponding to the sent narrowing condition and sorted in order of indication rank.

In a step S205 subsequent to the step S204, the terminal device 3 indicates the received content information pieces on the display section 32 therein. The sequential processing that has started from the step S201 ends at the step S205. Preferably, the content information pieces are indicated on the display section 32 while being arranged in order of indication rank. Among the content information pieces sorted in order of indication rank, a prescribed number of successive ones starting from the content information piece with the highest indication rank may be selected. In this case, the selected content information pieces are indicated while being arranged in order of indication rank or being not arranged.

In the case where the appropriate contents selecting process is performed at every prescribed timing, the step S202 may be skipped.

In the embodiment of this invention, the priority degrees of the respective content information pieces corresponding to the narrowing condition are calculated from the scores and the random numbers. The indication ranks of the respective content information pieces are decided in order of decreasing priority degree. Accordingly, there is a high probability that a content information piece with a higher score will be assigned a higher indication rank. The content information pieces are indicated according to the ranks thereof. Thus, the indication of the content information pieces provides a result reliable to the user and full of variety.

In the embodiment of this invention, the browse count for a same narrowing condition may be managed. The browse count means the number of times the content information pieces corresponding to the narrowing condition are browsed. The priority degrees of the content information pieces are calculated from a random number list which changes for every prescribed increase in browse count. Thus, the indication ranks of the content information pieces change for every prescribed increase in browse count. On the other hand, until an increase in browse count reaches the prescribed value, the indication ranks of the content information pieces remain unchanged. Accordingly, when the user consecutively checks the content information pieces corresponding to the narrowing condition, the user can feel that the indication of the content information pieces is systematic. Thus, the indication of the content information pieces is reliable to the user. In addition, it is possible to prevent the content information pieces desired to be checked by the user from being unindicated.

In the embodiment of this invention, the browse count for a same narrowing condition may be managed on a user-by-user basis. In this case, the browse count means the number of times the content information pieces corresponding to the narrowing condition are browsed by a user. The priority degrees of the content information pieces are calculated from a random number list which changes for every prescribed increase in browse count. When the user consecutively checks the content information pieces corresponding to the same narrowing condition, the user can feel that the indication of the content information pieces is systematic. Thus, the indication of the content information pieces is reliable to the user. In addition, it is possible to prevent the content information pieces desired to be checked by the user from being unindicated.

In the embodiment of this invention, the priority degrees of the content information pieces may be calculated from the random number list which changes at prescribed time intervals. In this case, the indication of the content information pieces changes at the prescribed time intervals also. It can be expected that the user will use the service many times while considering the prescribed time intervals.

The prescribed time intervals may be replaced by variable time intervals. For service where the moments of accesses from users are unevenly distributed, it is preferable that the time intervals are short in the time during which accesses are fewer. Thereby, it can be expected that the service can attract user's interest. It can also be expected that the user will use the service in the time during which usually, the user does not.

The time intervals may be varied at random. In this case, the user can not see the timings at which the indication of the content information pieces is changed. Thus, the user can expect that if the service is accessed at this time, the indication of the content information pieces may be changed. Accordingly, it can be expected that the user will frequently use the service.

This invention includes the program or programs for enabling the computer or computers to implement the functions of the information processing apparatus in the embodiment thereof. The program or programs may be read out from a recording medium before being installed on the computer or computers. Alternatively, the program or programs may be transmitted via a communication network before being installed on the computer or computers. The embodiment of this invention may be modified in various ways. These modifications are in this invention.

What is claimed is:

1. A method of processing information to select one or more from a plurality of content information pieces on the basis of a narrowing condition, comprising the steps of:
calculating scores of the respective content information pieces, the scores being degrees of conformity between the content information pieces and the narrowing condition respectively;
selecting appropriate ones from the content information pieces on the basis of the narrowing condition, the appropriate information pieces conforming to the narrowing condition;
acquiring a random number sequence;
computing priority degrees of the respective appropriate information pieces from the scores of the appropriate information pieces and the acquired random number sequence; and
deciding indication ranks of the respective appropriate information pieces on the basis of the computed priority degrees.

2. A method as recited in claim 1, wherein the selecting step comprises selecting the appropriate information pieces from the content information pieces on the basis of the calculated scores.

3. A method as recited in claim 1, wherein the acquiring step comprises acquiring the random number sequence which changes each time the priority degrees are computed.

4. A method as recited in claim 1, further comprising the step of counting the number of times the priority degrees are computed to obtain a count number, and wherein the acquiring step comprises acquiring the random number sequence which changes for every prescribed increase in the count number.

5. A method as recited in claim 1, further comprising the steps of:
receiving the narrowing condition;
receiving a use subject identifier for identifying a terminal device sending the narrowing condition or a user using the terminal device sending the narrowing condition;
counting a number of times the appropriate information pieces corresponding to the narrowing condition are required to be browsed; and
storing the use subject identifier, the narrowing condition, and the counted number in a store device while relating the use subject identifier, the narrowing condition, and the counted number with each other;
wherein the acquiring step comprises acquiring the counted number from the store device, and acquiring the random number sequence which changes for every prescribed increase in the counted number.

6. A method as recited in claim 1, wherein the acquiring step comprises acquiring the random number sequence which changes at every prescribed time interval.

7. A method as recited in claim 1, wherein the acquiring step comprises acquiring the random number sequence which changes at time intervals depending on day of the week or season.

8. A method as recited in claim 1, wherein the deciding step comprises sorting the appropriate information pieces in order of decreasing score, choosing from the sorted appropriate information pieces successive ones with the scores higher than a prescribed value or a prescribed number of successive ones starting from the one with the highest score, and deciding the indication ranks of the respective chosen appropriate information pieces.

9. A method as recited in claim 1, wherein the computing step comprises, for each of the appropriate information pieces, computing the priority degree thereof from the product or sum of a random number in the random number sequence and a value depending on the score.

10. A method as recited in claim 1, wherein the computing step comprises, sorting the appropriate information pieces in order of decreasing score, assigning serial score ranks to the sorted appropriate information pieces respectively, and computing the priority degrees of the respective appropriate information pieces from the score ranks and the random number sequence.

11. A method as recited in claim 10, wherein the computing step comprises, for each of the appropriate information pieces, computing the priority degree thereof from the product or sum of a random number in the random number sequence and a value which decreases as the related score rank is lower.

12. A method as recited in claim 1, wherein the narrowing condition includes a use subject identifier for identifying a user and the appropriate information pieces are those to be recommended to the user identified by the use subject identifier, and the score of each of the appropriate information pieces increases as the degree to which the appropriate information piece is to be recommended increases.

13. A method as recited in claim 1, wherein the appropriate information pieces relate to prescribed content information, and the score of each of the appropriate information pieces increases as the degree to which the appropriate information piece relates to the prescribed content information increases.

14. A method as recited in claim 1, wherein the narrowing condition comprises a search condition including one or more keywords, and the score of each of the appropriate information pieces increases as the degree to which the appropriate information piece conforms to the search condition increases.

15. A method as recited in claim 1, further comprising the steps of:
receiving the narrowing condition; and
sending a set of the appropriate information pieces and information representing the indication ranks thereof or a set of a prescribed number of successive ones among the appropriate information pieces arranged in order of lowering indication rank and information representing the indication ranks of said successive ones.

16. A method as recited in claim 15, further comprising the steps of:
sending the narrowing condition from a terminal device to a server device;
receiving, at the terminal device, the appropriate information pieces and the information representing the indication ranks thereof from the server device; and
indicating the received appropriate information pieces on a display section of the terminal device in accordance with the indication ranks thereof.

17. An apparatus for processing information to select one or more from a plurality of content information pieces on the basis of a narrowing condition, comprising:
a calculating section configured to calculate scores of the respective content information pieces, the scores being degrees of conformity between the content information pieces and the narrowing condition respectively;
a selecting section configured to select appropriate ones from the content information pieces on the basis of the narrowing condition, the appropriate information pieces conforming to the narrowing condition;
an acquiring section configured to acquire a random number sequence;
a computing section to compute priority degrees of the respective appropriate information pieces from the scores of the appropriate information pieces and the acquired random number sequence; and
a deciding section configured to decide indication ranks of the respective appropriate information pieces on the basis of the computed priority degrees.

18. A computer program for enabling a computer to implement processing information to select one or more from a plurality of content information pieces on the basis of a narrowing condition, the computer program enabling the computer to implement the steps of:
calculating scores of the respective content information pieces, the scores being degrees of conformity between the content information pieces and the narrowing condition respectively;
selecting appropriate ones from the content information pieces on the basis of the narrowing condition, the appropriate information pieces conforming to the narrowing condition;
acquiring a random number sequence;
computing priority degrees of the respective appropriate information pieces from the scores of the appropriate information pieces and the acquired random number sequence; and
deciding indication ranks of the respective appropriate information pieces on the basis of the computed priority degrees.
